(19) United States
(12) Patent Application Publication
(10) Pub. No.: US 2003/0161395 A1
(43) Pub. Date: Aug. 28, 2003

(54) Method and apparatus for improving channel selection performance of compressed digital video systems

(76) Inventor: Charles Calvin Byers, Wheaton, IL (US)

Correspondence Address: Docket Administrator (Rm. 3J-219), Lucent Technologies Inc., 101 Crawfords Corner Road, Holmdel, NJ, 07733-3030, US

(21) Appl. No.: 10/085,229

(22) Filed: Feb. 28, 2002

(51) Int. Cl. H04N 7/12

(52) U.S. Cl. 375/240.01; 375/240.11

(57) ABSTRACT

The present invention provides a customer premises device and method for improving the channel selection of compressed digital video systems and multimedia systems. The customer premises device includes multiple decoders. Each of the decoders receives an individual stream that is part of a broadcast stream received by the customer premises device. The customer premises device determines the most likely channel that a user of the system will select next and decodes the stream associated with that channel.

### FIELD OF THE INVENTION

The present invention relates in general to compressed digital video systems, and in particular to channel selection performance in compressed digital video systems.

### BACKGROUND OF THE INVENTION

Many modern multimedia systems use compression to improve the bandwidth efficiency of the transport of content from a live or stored source to broadcast subscribers. As used herein, the term “content” refers to information streams such as video, audio, and data. One example of data content is a stock ticker. Examples of such multimedia systems include digital cable TV systems, satellite networks, web radio, and training networks. These systems have the advantage of providing many hundreds of broadcast channels on a reasonable bandwidth.

In typical multimedia systems, an encoder associated with the source of each media stream accepts an uncompressed signal, compresses the signal, adds control information to the compressed signal, and forwards the compressed signal to the broadcast channel. A decoder located at each destination of the compressed stream selects the appropriate digital transport stream, removes the control information, and performs a decompression to reconstruct a representation of the original signal for display.

Current digital video systems can be better understood with reference to FIG. 1. FIG. 1 is a block diagram of a compressed, multi-channel digital video system 100 in accordance with the prior art. Programming originates in cameras 110 and 114, microphones 112 and 116, and tape machines 118 and 120. Although only four video sources are depicted in FIG. 1, it should be understood that practical systems include hundreds of channels, and are not limited to video. Video can also be sourced from digital storage, such as disk drives.

Signals from these program sources are carried over links to program encoders. Signals from camera 110 are carried over link 111 to encoder 122, signals from camera 114 are carried over link 115 to encoder 124, signals from microphone 112 are carried over link 113 to encoder 122, signals from microphone 116 are carried over link 117 to encoder 124. Signals from tape machine 118 are carried over link 119 to encoder 126 and signals from tape machine 120 are carried over link 121 to encoder 128. Links 111, 113, 115, 117, 119, and 121 are preferably baseband analog signals, but can alternately be uncompressed digital signals.

Encoders 122, 124, 126 and 128 perform compression on the received signals, preferably using a compression algorithm such as MPEG-2 (Moving Pictures Experts Group 2). Encoder 122 produces compressed transport stream 123, encoder 124 produces compressed transport stream 125, encoder 126 produces compressed transport stream 127 and encoder 128 produces compressed transport stream 129. Compressed transport streams 123, 125, 127, and 129 are digital signals carrying compressed video signals between network elements.

Multiplexer (mux) 130 combines the compressed transport streams 123, 125, 127 and 129 into a broadcast channel 140. Broadcast channel 140 can be transported on a variety of broadband transport technologies, including coaxial cable, terrestrial microwave radio, satellite and fiber optic link. Broadcast channel 140 typically has a large fan out, where thousands or millions of customer premises devices receive the same multiplexed stream, such as satellite television systems or digital cable televisions systems.

For clarity, only one such device is depicted in FIG. 1, customer premises device 150. Customer premises device 150 includes the equipment needed to receive broadcast channel 140. Customer premises device 150 comprises a stream selector 160, a decoder 170, a display 180, and a user interface 190. Stream selector 160 demultiplexes a single compressed digital channel from the plurality of channels present in broadband channel 140. Stream selector 160 also preferably includes capabilities for features like decryption and parental control. A single compressed digital transport stream 165 emerges from the stream selector and is passed to decoder 170. Decoder 170 performs decompression on compressed digital transport stream 165 to produce a decoded program. Link 175 conveys the decoded program to display 180, where the picture and/or sound are reproduced.

User interface 190 permits the user of customer premises device 150 to select the desired program channel by controlling the demultiplexing settings of stream selector 160. Remote control 195 is provided for convenience and preferably sends infrared signals to user interface 190 to control customer premises device 150.

Compression, however, is not without drawbacks. Some delay and artifacts are introduced. Compression algorithms that attain maximum bandwidth efficiency typically remove a great deal of redundant information from the content streams, and encode the results so as to provide a factor of 2 to 200 less bandwidth than the uncompressed signals. Consequently, decoders must stay synchronized with the media stream created by the encoder. Acquiring this synchronization often can take several seconds.

Many compression standards make use of the recent history of a signal in order to reduce the instantaneous bandwidth necessary to transmit the signal. The current signal is derived from knowing the state of the signal in the past. Only changes to the signal are transported. This requires less bandwidth than would be needed to transport the entire signal continuously.

For example, the MPEG (Moving Pictures Experts Group) standard for compression of video signals represents a moving image as a series of three frame types. The first frame type, called an intra coded frame (I-frame), transmits an image without any reference to other frames in the program. I-frames are usually transmitted at the start of a program, after a scene change, or at the expiration of a timer.

The second frame type, the forward predicted (P-frame), is created by transporting only the differences between the last I-frame and the current picture. A third type of frame, the B-frame, uses differences both from the previous I-frame and the next I-frame in the frame sequence, as well as differences with P-frames.

All three frame types, I-frames, P-frames and B-frames, are multiplexed along with audio samples and control information into a single data stream, called the MPEG transport stream. By minimizing the number of information-intensive I-frames and maximizing the number of information-lean P-frames and B-frames, highly efficient bandwidth compression of the transport stream can be realized.

FIG. 2 depicts a representative example of the frame patterns of an MPEG compressed multimedia stream in accordance with the prior art. Seven MPEG frames of three different types are represented in sequence. The dependencies on some frames when predicting other frames are also shown.

The coding sequence starts with an I-frame 210. I-frame 210 represents the basis upon which subsequent frames will be derived. I-frames require a comparatively large number of bits (and hence a large storage or channel bandwidth), so it is desirable to minimize the frequency of I-frame occurrence if high degrees of compression are to be achieved. Forward predicted frames (P-frames) 240 and 260 transmit only the differences between the current picture and the last I-frame or P-frame, so their information content is much less than I-frame 210. Vectors 216 and 246 represent the predictive dependencies that P-frame 240 has on I-frame 210, and P-frame 260 has on P-frame 240, respectively.

In accordance with the example depicted in FIG. 2, B-frames 220, 230 and 250 are predicted both in forward and backward directions from I-frame 210 or P-frames 240 and 260. The information content of B-frames is also low. Applying deltas to I-frame 210 and P-frame 240, with these dependencies shown as vectors 212 and 244 derives B-frame 220. Similarly, B-frame 230 is based on I-frame 210 and P-frame 240 through dependencies 214 and 242, and B-frame 250 is based on P-frame 240 and P-frame 260 through dependency vectors 248 and 262.

A second I-frame, I-frame 270, is shown in FIG. 2. I-frame 270 has no dependencies on previous frames. MPEG encoders make the decision to stop the predictive cycle of P-frames and B-frames and produce an I-frame under several circumstances. I-frames are produced at the start of a program. Also, after a video scene change, where nearly all the picture is different than the previous frame, an I-frame is generated, because generating an I-frame takes less bits than representing all the changes needed to produce an acceptable P-frame or B-frame. Finally, MPEG encoders often have a timer or frame counter where the generation of an I-frame is forced at regular intervals, to prevent the accumulation of systematic errors in the picture.

A difficulty arises when a viewer changes between broadcast channels while using a system that relies on a compression standard like MPEG. When the viewer commands a channel change, the data routing function in the network or in the customer premises equipment disconnects the MPEG decoder from the previous channel's transport stream and connects it to the next channel's transport stream. The decoder must then delete all incoming P-frames and B-frames and wait for a complete I-frame before it can assemble its first picture and begin displaying the new channel. During this wait, the screen is either blank or displays various patterns or video noise as the decoder attempts to apply the new changes to the old channel's I-frame. Depending upon the parameters selected by the source encoder of the new channel, and the program's contents, several seconds may elapse before an I-frame arrives and the video on the new channel is displayed properly.

This delay of several seconds can be objectionable to users who are accustomed to channel surfing on an analog broadcast or cable TV environment. Analog tuners respond almost immediately to the command to change channels, allowing an impatient user to scan through a few channels per second, and not the few seconds per channel often experienced on digital video systems.

Therefore, a need exists for a method and apparatus to reduce the channel selection delay on compressed digital multimedia systems, and especially multi-channel digital video systems.

### BRIEF SUMMARY OF THE INVENTION

The above problem is solved and advance is made in the art through the use of a pool of multiple decoder channels running in parallel, with each channel remaining synchronized to its own multimedia stream. The method of the present invention provides for greatly improved channel selection speed without requiring one decoder for each channel in the transport stream. This is accomplished by providing an algorithm that predicts the most likely channels that a user will tune to next, and decoding those channels prior to their selection.

The method of the present invention provides for greatly improved channel selection performance in compressed digital video systems by including a plurality of decoders at a customer premises device. Each of the decoders receives a separate individual stream from the input broadband stream. The separate individual stream that each of the plurality of decoders receives is determined in accordance with the present invention.

In accordance with an exemplary embodiment of the present invention, a control processor determines which channels the user is most likely to tune to next. In one embodiment of the present invention, the control processor includes enough decoders to receive the current channel being viewed, the next channel in the channel list, the previous channel in the channel list, the last channel viewed, the next channel in a favorites list, and the previous channel in the favorites list. In this manner, the system will predictively receive and decode the I-frame for the next channel to be viewed, thereby substantially decreasing the amount of time it takes for the display to actually display an image to the user.

### BRIEF DESCRIPTION OF THE SEVERAL VIEWS OF THE DRAWINGS

FIG. 1 is a block diagram of a digital multimedia system in accordance with the prior art.

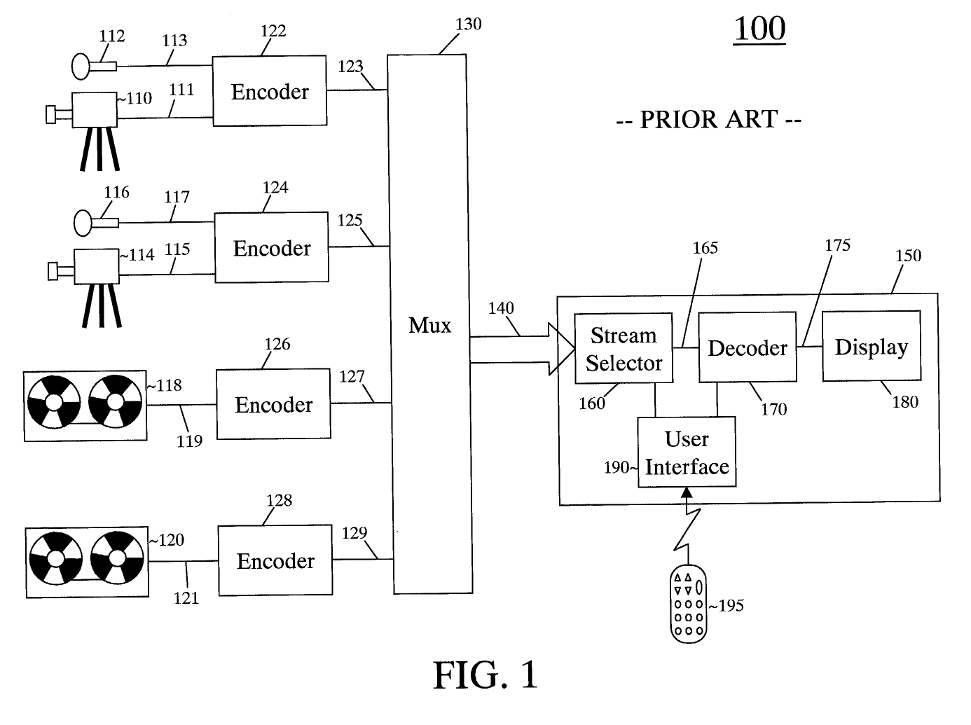

FIG. 2 depicts the frame patterns of an MPEG compressed multimedia stream in accordance with the prior art.

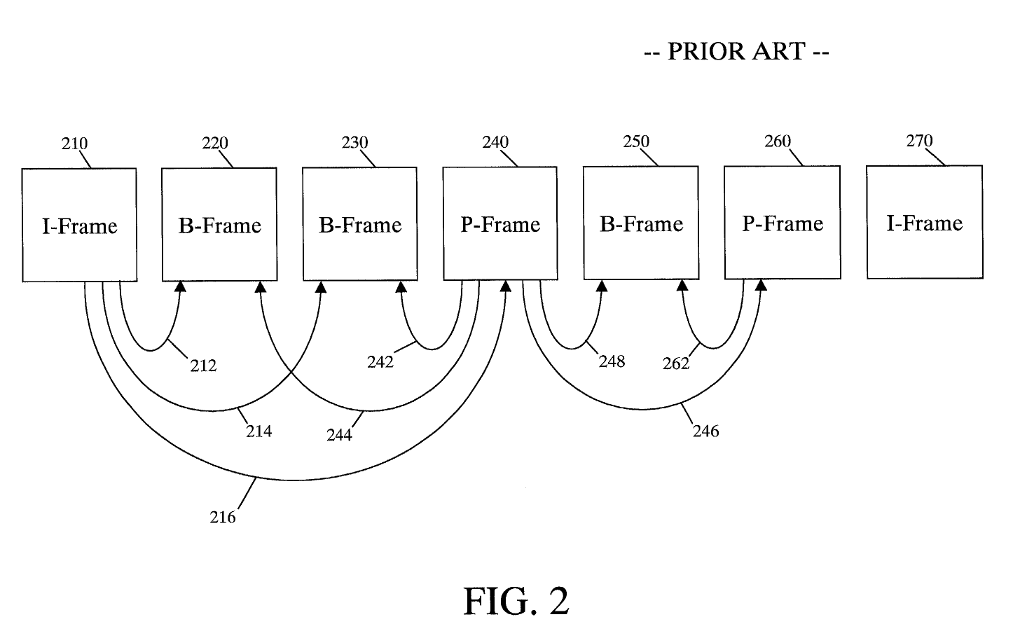

FIG. 3 depicts a customer premises device in accordance with an exemplary embodiment of the present invention.

FIG. 4 depicts a user interface in accordance with an exemplary embodiment of the present invention.

FIG. 5 depicts a generalized flow chart in accordance with an exemplary embodiment of the present invention.

FIG. 6 depicts a flow chart relating to the case when the channel up button is pressed on a remote control device in accordance with an exemplary embodiment of the present invention.

FIG. 7 depicts a flow chart relating to the case when the channel down button is pressed on a remote control device in accordance with an exemplary embodiment of the present invention.

FIG. 8 depicts a flow chart relating to the case when a favorite channel up button is pressed on a remote control device in accordance with an exemplary embodiment of the present invention.

FIG. 9 depicts a flow chart relating to the case when a favorite channel down button is pressed on a remote control device in accordance with an exemplary embodiment of the present invention.

FIG. 10 depicts a flow chart relating to the case when the last viewed channel button is pressed on a remote control device in accordance with an exemplary embodiment of the present invention.

FIG. 11 depicts a flow chart relating to the case when a channel is selected using the numeric keypad on a remote control device in accordance with an exemplary embodiment of the present invention.

### DETAILED DESCRIPTION OF THE INVENTION

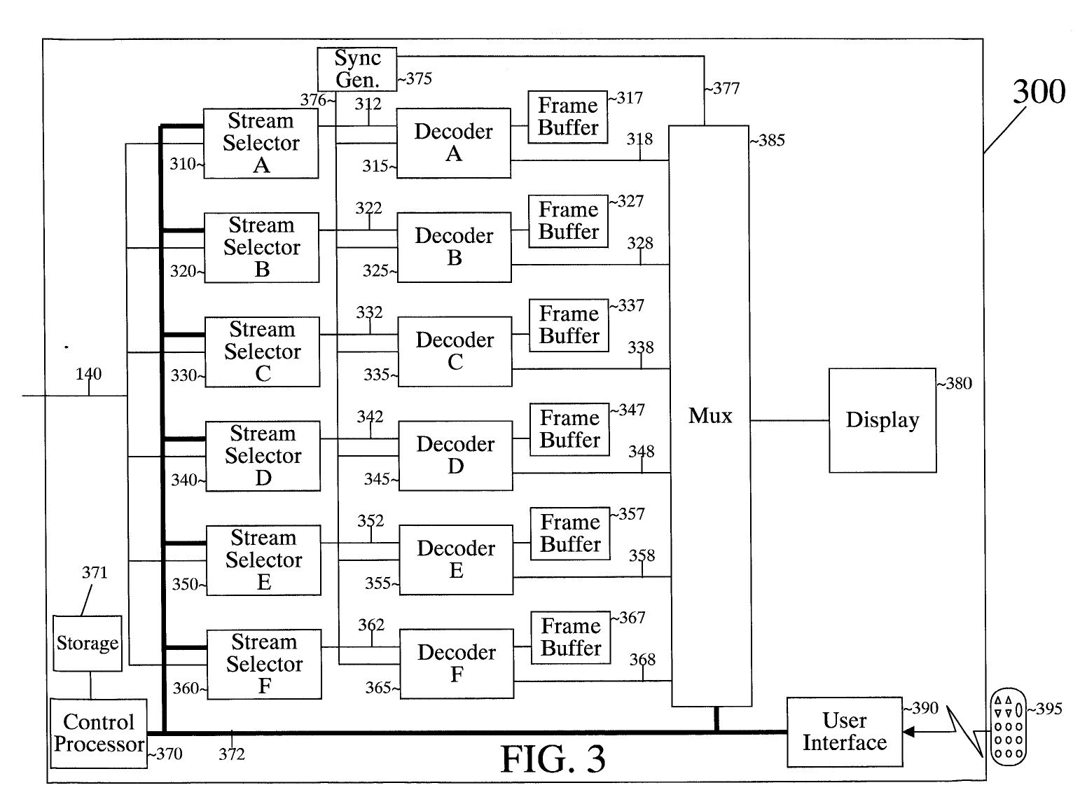

The present invention can be better understood with reference to FIGS. 3-11. FIG. 3 depicts a customer premises device 300 in accordance with an exemplary embodiment of the present invention. Customer premises device 300 comprises a plurality of stream selectors 310, 320, 330, 340, 350, and 360, a plurality of decoders 315, 325, 335, 345, 355, and 365, a plurality of frame buffers 317, 327, 337, 347, 357, and 367, a control processor 370, a synchronization generator 375, a display 380, a multiplexer 385, and a user interface 390.

In accordance with the exemplary embodiment depicted in FIG. 3, customer premises device 300 comprises six sets of stream selectors, decoders, and frame buffers. Six has been chosen in this embodiment to allow for one set of stream selector, decoder, and frame buffer for the currently viewed channel, a second set for the next channel up in the channel list, a third set for the next channel down the current channel, a fourth set for the next channel up in a favorites list defined by the user, a fifth set for the next channel down in the favorites list, and a sixth set for the last channel viewed prior to viewing the current channel. It should be understood that customer premises device 300 could include more or less sets of stream selectors, decoders, and buffers.

In an exemplary embodiment of the present invention, a broadband stream arrives on broadband transport facility 140. Broadband stream 140 is fanned out to six parallel stream selectors 310, 320, 330, 340, 350 and 360. Stream selectors 310, 320, 330, 340, 350 and 360 each are configured to isolate an individual compressed transport stream, preferably MPEG 2, from broadband transport facility 140, and relay these streams over links 312, 322, 332, 342, 352 and 362, respectively, to a set of six parallel decoders 315, 325, 335, 345, 355, and 365, respectively.

Decoders 315, 325, 335, 345, 355, and 365 each receive a single transport stream, synchronize to the transport stream, search for an I-frame, and perform video decompression on the transport stream. Each decoder 315, 325, 335, 345, 355, and 365 has its own frame buffer 317, 327, 337, 347, 357 and 367, respectively, to store the video frames as they are decompressed. Frame buffers 317, 327, 337, 347, 357 and 367 are preferably random access memory (RAM). Decoders 315, 325, 335, 345, 355, and 365 extract frames from the frame buffers to create the six video signals, which are sent to multiplexer 385 over links 318, 328, 338, 348, 358 and 368.

Multiplexer 385 selects a single video signal from among the six decoder outputs, and transports the selected video stream to display 380. Although not shown, there are also audio paths from the decoders, through a multiplexer and to the speakers associated with display 380.

Stream selectors 310, 320, 330, 340, 350 and 360 and multiplexer 385 are controlled by control processor 370 over shared control bus 372. Storage 371 holds databases of favorite channel lists and other configuration information. The favorite channel list is preferably provided by the user of customer premises device 300. User commands to the control processor 370 are received at user interface 390 from remote control 395.

A centralized synchronization generator 375 creates a sync bus 376 that insures that all six decoders 315, 325, 335, 345, 355, and 365 are time-aligned with the same horizontal and vertical synchronization. This alignment insures that video signals 318, 328, 338, 348, 358 and 368 all start their vertical and horizontal retraces simultaneously. This eliminates synchronization disruptions that may be perceived on display 380 as multiplexer 385 changes input sources, and also facilitates picture-in-picture and split screen effects. Signal 377 insures that multiplexer 385 switches during the vertical interval of the video signal, which improves display quality, and also provides a blank screen signal that multiplexer 385 can select during the times before the selected decoder has completely decoded the transport stream.

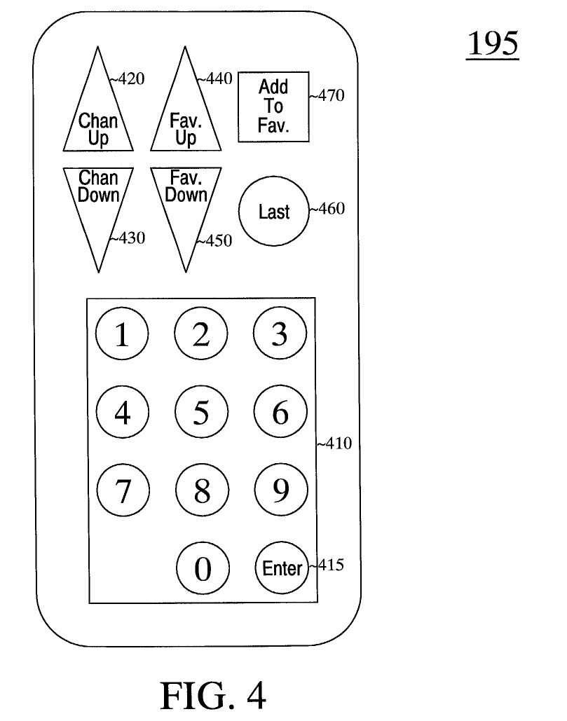

FIG. 4 depicts remote control 395 in accordance with an exemplary embodiment of the present invention. As depicted in FIG. 4, remote control 395 is an infrared control device that works by sending an infrared signal to user interface 390. Remote control 395 can alternately be a front panel control, control menu, or the like that controls the channel selection functions of a display device, such as a television. Remote control 395 preferably includes numeric keypad 410, enter key 415, channel up button 420, channel down button 430, favorite list up button 440, favorite list down button 450, last button 460, and add to favorites button 470.

Remote control 395 includes a number of buttons that a user can activate to select the next channel to be viewed. Numeric keypad 410 is used to directly enter a channel number. Since channel numbers on advanced digital video systems can be four digits long, enter key 415 permits the user to signify the entry of the last digit of a selected channel.

Users engaged in the rapid channel surfing this invention facilitates usually do not use numeric keyboard 410, but instead prefer channel up button 420 and channel down button 430. Channel up button 420 advances the channel being viewed to the next highest channel in the channel list. Channel down button 430 advances the channel number being viewed to the next lowest channel below the currently viewed channel in the channel list. In an exemplary embodiment, a database of valid channel numbers is consulted so that unused channels (or those that are blocked or not subscribed to) are skipped when advancing to the next channel up or next channel down button, so that the next channel up or next channel down may not be immediately adjacent to the channel currently being viewed. Also, when the extreme high or low channel number is reached, appropriate roll-over actions are taken.

Another way to channel surf rapidly is provided by the favorite channel list. The user pre-configures a circular list of a subset of all the valid channels representing the most-viewed channels. Favorite list up button 440 advances a pointer through this list. Favorite list down button 450 decrements the pointer through the list of favorite channels. Add to favorite list button 470 adds the current channel to the favorites list if it is not currently on the list or subtracts the current cannel from the favorite list if it is currently on the list.

Last button 460 rapidly skips to the previously viewed channel. Last button 460 is often used when a user is interested in two programs on widely separated channels. The user tunes to one channel, enters the other channel on numeric keyboard 410, and uses the last key 460 to rapidly toggle between the two channels.

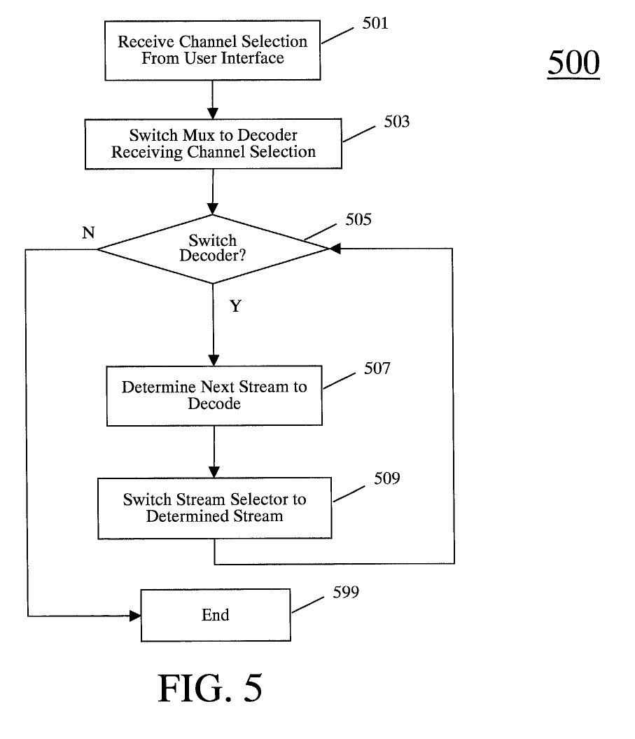

FIG. 5 depicts a generalized flow chart 500 in accordance with an exemplary embodiment of the present invention.

The customer premises device receives (501) a channel selection from the user interface. The user interface may receive the channel selection from a button on the television, from a remote control, or by other means of choosing a channel in the system. The customer premises device switches (503) the multiplexer to the decoder that is currently receiving and synchronized with the stream of the selected channel.

The customer premises device determines (505) if a decoder is currently receiving a stream that is no longer predictively valuable and should therefore be changed to receive a stream that is predictively valuable. If all decoders are on the optimal predictive streams, the process ends (599).

If in step 505 it is determined that a decoder should switch to a different stream, the customer premises device determines (507) the next stream that a decoder should receive to decode.

The customer premises device switches (509) the stream selector associated with the chosen decoder to filter the chosen channel from the broadcast stream. The process then returns to step 505 to determine if another decoder should be switched to a different stream.

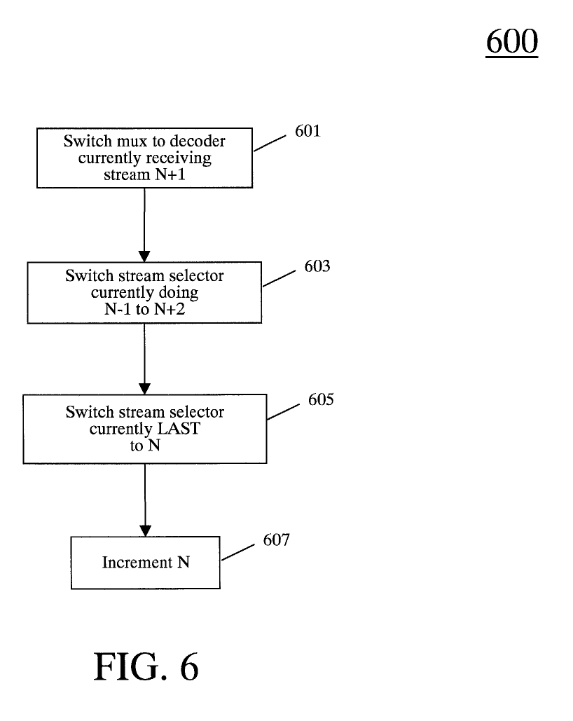

FIG. 6 depicts a flow chart 600 relating to the case when the channel up button is pressed on a remote control device in accordance with an exemplary embodiment of the present invention. In this case, the channel being viewed prior to the channel up button being pressed is depicted by N. The customer premises device switches (601) the multiplexer to the decoder currently receiving stream N+1, which is the next channel in the channel list. The selected channel N+1 appears on the display immediately.

The customer premises device switches (603) the stream selector currently on channel N−1 to channel N+2. In this manner, the stream selector that was receiving the channel below the channel N will begin receiving and decoding the stream from the channel above the newly selected channel, in anticipation of subsequent channel up events.

The customer premises device switches (605) the input to the stream selector that was receiving the last-viewed channel to now receive the stream from channel N, since channel N is now becoming the last-viewed channel. The customer premises device increments (607) N.

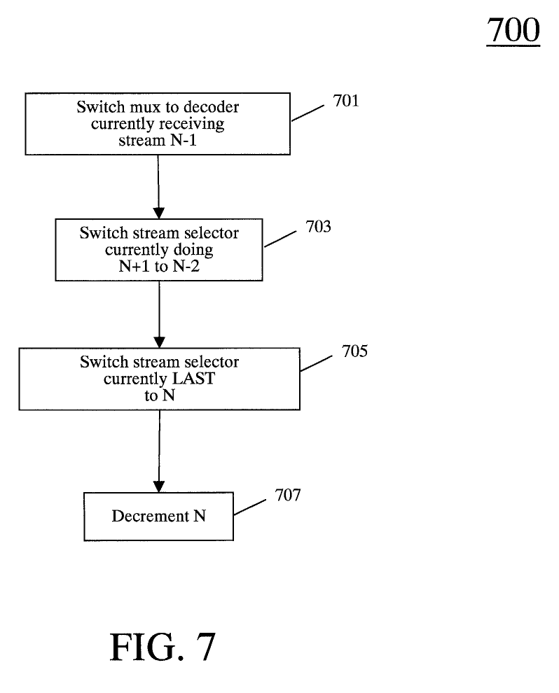

FIG. 7 depicts a flow chart 700 relating to the case when the channel down button is pressed on a remote control device in accordance with an exemplary embodiment of the present invention. In this case, the channel being viewed prior to the channel down button being pressed is depicted by N. The customer premises device switches (701) the multiplexer to the decoder currently receiving stream N−1, which is the previous channel in the channel list. The selected channel N−1 appears on the display immediately.

The customer premises device switches (703) the stream selector currently on channel N+1 to channel N−2. In this manner, the stream selector that was receiving the channel above the channel N will begin receiving and decoding the stream from the channel below the newly selected channel, in anticipation of subsequent channel down events.

The customer premises device switches (705) the input to the stream selector that was receiving the last-viewed channel to now receive the stream from channel N, since channel N is now becoming the last-viewed channel. The customer premises device decrements (707) N.

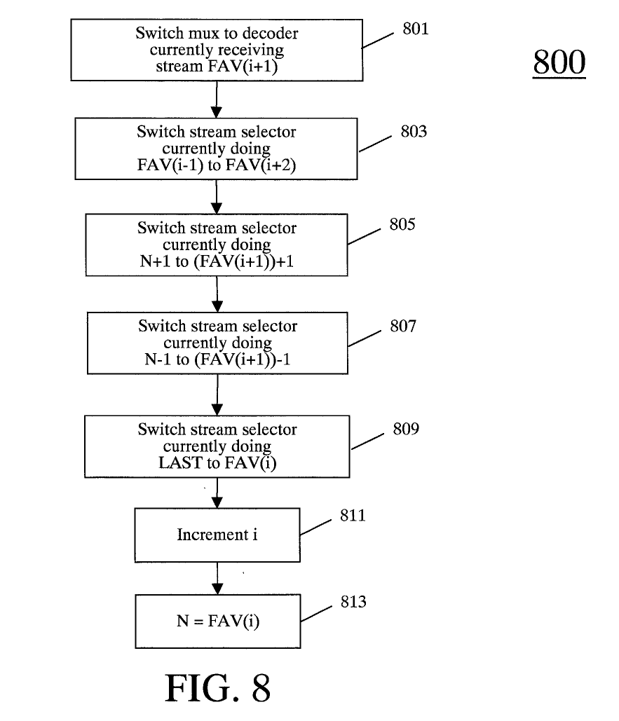

FIG. 8 depicts a flow chart 800 relating to the case when a favorite channel up button is pressed on a remote control device in accordance with an exemplary embodiment of the present invention. In this case, the channel being viewed prior to the favorite channel up button being pressed is depicted by FAV(i) and the next channel in the favorites list is depicted by FAV(i+1). It should be understood that the currently received channel and the previous channel in the favorites channel list may not be adjacent channels. There may be numerous channels separating these two channels. Index variable i is maintained as a pointer into the FAV array.

The customer premises device switches (801) the multiplexer to the decoder currently receiving stream FAV(i+1), which is the next channel in the favorites channel list. The selected channel FAV(i+1) appears on the display immediately.

The customer premises device switches (803) the stream selector currently on channel FAV(i−1) to channel FAV(i+2). In this manner, the stream selector that was receiving channel FAV(i−1) in the favorites list will begin receiving the stream from channel FAV(i+2) in the favorites list, in anticipation of subsequent favorite up events.

The customer premises device switches (805) the input of the stream selector that was receiving the channel N+1 to the channel above the newly selected favorite channel. Since the newly selected channel is FAV(i+1), the channel above this newly selected channel will be FAV(i+1)+1.

The customer premises device switches (807) the input of the stream selector that was receiving the channel N−1 to the channel below the newly selected favorite channel. Since the newly selected channel is FAV(i+1), the channel below this newly selected channel will be FAV(i+1)−1.

The customer premises device switches (809) the input to the stream selector that was receiving the last-viewed channel to now receive the input stream from channel FAV(i), since channel FAV(i) is now becoming the last-viewed channel. The customer premises device increments (811) i. FAV(i) is copied (813) into N to maintain channel up and down functionality.

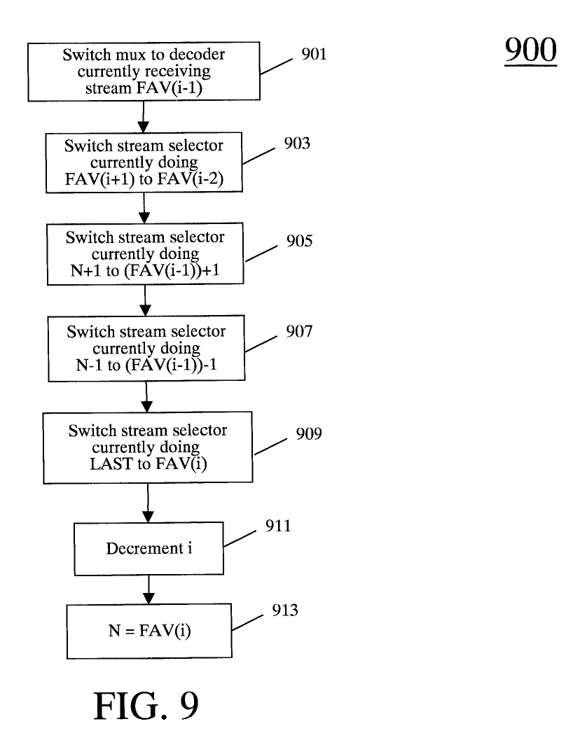

FIG. 9 depicts a flow chart 900 relating to the case when a favorite channel down button is pressed on a remote control device in accordance with an exemplary embodiment of the present invention. In this case, the channel being viewed prior to the favorite channel down button being pressed is depicted by FAV(i) and the previous channel in the favorites list is depicted by FAV(i−1).

The customer premises device switches (901) the multiplexer to the decoder currently receiving stream FAV(i−1), which is the previous channel in the favorites channel list. The selected channel FAV(i−1) appears on the display immediately.

The customer premises device switches (903) the stream selector currently on channel FAV(i+1) to channel FAV(i−2). In this manner, the stream selector that was receiving the channel above the previously viewed channel in the favorites list will begin receiving the stream from the channel below the newly selected channel in the favorites list in anticipation of subsequent favorite down events.

The customer premises device switches (905) the input of the stream selector that was receiving channel (N+1) to the channel above the newly selected favorite channel. Since the newly selected channel is FAV(i−1), the channel above this newly selected channel will be FAV(i−1)+1.

The customer premises device switches (907) the input of the stream selector that was receiving the channel (N−1) to the channel below the newly selected favorite channel. Since the newly selected channel is FAV(i−1), the channel below this newly selected channel will be FAV(i−1)−1.

The customer premises device switches (909) the input to the stream selector that was receiving the last-viewed channel to now receive the input stream from channel FAV(i), since channel FAV(i) is now becoming the last-viewed channel. The customer premises device decrements (911) i. FAV(i) is copied (913) into N to maintain channel up and down functionality.

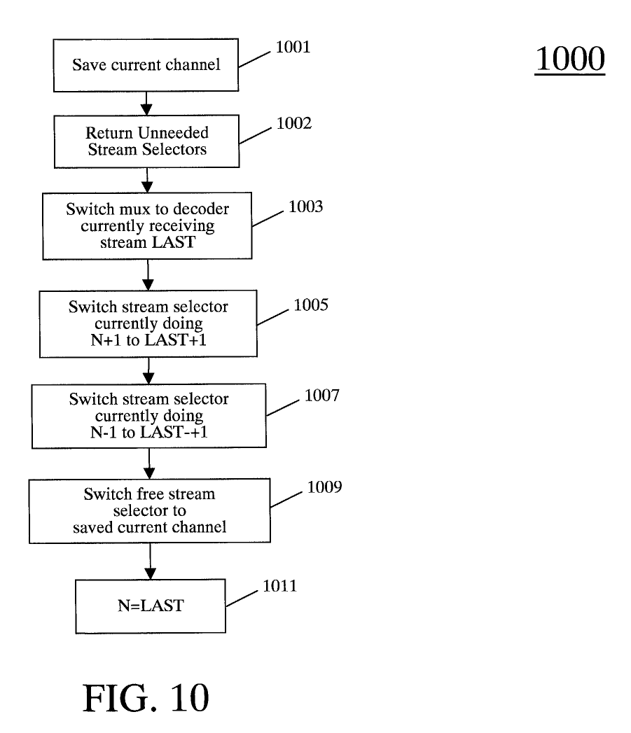

FIG. 10 depicts a flow chart 1000 relating to the case when the last viewed channel button is pressed on a remote control device in accordance with an exemplary embodiment of the present invention. In this case, the last viewed channel button being pressed is depicted by N. The customer premises device saves (1001) the current channel number. All decoders not predictably related to the entered channel value are declared (1002) free.

The customer premises device switches (1003) the multiplexer to the decoder currently receiving the stream from the previously viewed channel. It should be understood that the currently received channel and the last channel may not be adjacent channels. There may be numerous channels separating these two channels. The selected channel LAST appears on the display immediately.

The customer premises device switches (1005) the stream selector currently on channel N+1 to channel LAST+1. In this manner, the stream selector that was receiving the channel above the currently viewed channel will begin receiving the stream from the channel above the newly selected channel.

The customer premises device switches (1007) the input of the stream selector that was receiving the channel below the currently viewed channel (N−1) to the channel below the newly selected channel, LAST−1.

The customer premises device switches (1009) the input of a free stream selector to the channel N, which was saved in step 1001. In this manner, if the user presses the last button again, the display will go back to the previously viewed channel. The customer premises device sets (1011) N to be equal to LAST.

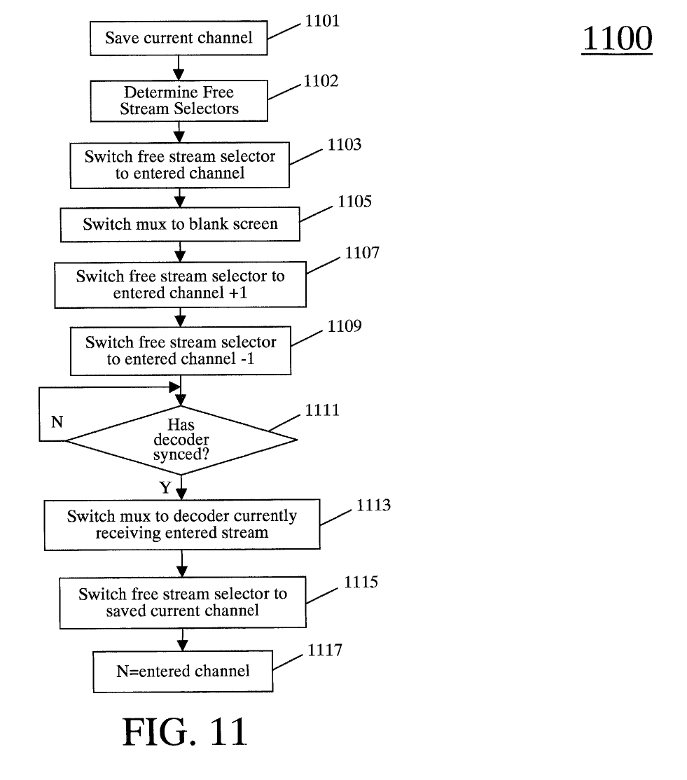

FIG. 11 depicts a flow chart 1100 relating to the case when a channel is selected using the numeric keypad on a remote control device in accordance with an exemplary embodiment of the present invention. Often keypad entered channels do not have a decoder currently receiving and synchronized to their streams. So some delay may be experienced when entering channels on the numeric keypad. This delay is exactly equivalent to what would be experienced for every channel change in current systems.

The customer premises device saves (1101) the channel currently being viewed. The channels being decoded currently are compared to the channel entered on the keypad. All decoders not predictably related to the entered channel value are declared (1102) free. The customer premises device switches (1103) the free stream selector to the entered channel. The customer premises device switches (1105) the multiplexer to a blank screen.

The customer premises device switches (1107) a free stream selector to the channel above the entered channel. The customer premises device switches (1109) a free stream selector to the channel below the entered channel. The customer premises device determines (1111) if the decoder has synchronized. If not, the customer premises device will continue to check until the decoder has synchronized. When the decoder has synchronized, the customer premises device switches (1113) the multiplexer to the decoder that is currently receiving the stream of the entered channel.

The customer premises device switches (1115) a free stream selector to the current channel, which was saved at step 1101. This allows the customer premises device to jump back to the previous channel if the user presses the “Last” button on the remote control. The customer premises device sets (1117) N to be equal to the entered channel.

The present invention thereby provides a customer premises device and method for providing improved channel selection performance in compressed digital video systems. By predictably receiving and decoding channels that are likely to be the next channel viewed by a user of the system, the time it takes to display the newly chosen channel's video is greatly reduced. In fact, the present invention provides for performance that in most cases will compare with analog systems.

The above embodiments are specific to multi-channel digital broadcast video systems. However, it should be understood that the scope of the present invention also incorporates other video compression standards, as well as multi-media systems incorporating multi channel audio and compressed data streams.

While this invention has been described in terms of certain examples thereof, it is not intended that it be limited to the above description, but rather only to the extent set forth in the claims that follow.

I claim:

1. A customer premises device for improving the channel selection performance of compressed multimedia systems, the customer premises device comprising:
a plurality of stream selectors for receiving a broadcast channel comprising a plurality of individual compressed transport streams, each of the plurality of stream selectors effective in isolating one of the plurality of individual compressed transport streams;
a plurality of decoders, each of the plurality of decoders coupled to one of the plurality of stream selectors, each of the plurality of decoders effective in receiving one of the plurality of individual compressed transport streams and decompressing the individual compressed transport stream into a decoded individual transport stream; and
a multiplexer coupled to the plurality of decoders for receiving the decoded individual transport streams and selecting one of the decoded individual transport streams.

2. A customer premises device in accordance with claim 1, wherein the multiplexer sends the selected decoded individual transport stream to a display.

3. A customer premises device in accordance with claim 1, the customer premises device further comprising a control processor for determining which of the decoded individual transport streams should be selected by the multiplexer.

4. A customer premises device in accordance with claim 1, the customer premises device further comprising a synchronization generator.

5. A customer premises device in accordance with claim 1, the customer premises device further comprising a user interface for receiving input commands.

6. A customer premises device in accordance with claim 1, wherein the plurality of decoders are synchronized to the broadcast channel.

7. A customer premises device in accordance with claim 1, the customer premises device further comprising a plurality of frame buffers.

8. A customer premises device in accordance with claim 7, wherein each of the plurality of frame buffers is associated with one of the plurality of decoders.

9. A customer premises device in accordance with claim 7, wherein the plurality of frame buffers comprises random access memory (RAM).

10. A customer premises device in accordance with claim 1, wherein the plurality of decoders are configured to anticipate the next channel to be selected.

11. A customer premises device in accordance with claim 10, wherein one of the plurality of decoders is associated with a channel up button.

12. A customer premises device in accordance with claim 10, wherein one of the plurality of decoders is associated with a channel down button.

13. A customer premises device in accordance with claim 10, wherein one of the plurality of decoders is associated with a favorites list increment button.

14. A customer premises device in accordance with claim 10, wherein one of the plurality of decoders is associated with a favorites list decrement button.

15. A customer premises device in accordance with claim 10, wherein one of the plurality of decoders is associated with a view last channel button.

16. A customer premises device in accordance with claim 1, wherein the plurality of decoders comprise MPEG video decompression engines.

17. A customer premises device in accordance with claim 1, further comprising a synchronization generator, the synchronization generator for keeping the plurality of de coders in synchronization.

18. A method for improving the channel selection performance of compressed digital video systems comprising:
receiving a broadband transport stream comprising a plurality of individual compressed transport streams;
receiving a channel selection, the channel selection indicating one of the plurality of individual compressed transport streams;
decoding the channel selection;
determining, based upon the channel selection, a second channel to decode.

19. A method for improving the channel selection performance of compressed digital video systems in accordance with claim 18, wherein the step of determining a second channel to decode comprises determining a second channel to decode based upon adjacency of the second channel to the first channel.

20. A method for improving the channel selection performance of compressed digital video systems in accordance with claim 18, wherein the step of determining a second channel to decode comprises determining a second channel to decode based upon the channel above the first channel in a channel list.

21. A method for improving the channel selection performance of compressed digital video systems in accordance with claim 18, wherein the step of determining a second channel to decode comprises determining a second channel to decode based upon the channel below the first channel in a channel list.

22. A method for improving the channel selection performance of compressed digital video systems in accordance with claim 18, wherein the step of determining a second channel to decode comprises determining a second channel to decode based upon the channel above the first channel in a favorite channel list.

23. A method for improving the channel selection performance of compressed digital video systems in accordance with claim 18, wherein the step of determining a second channel to decode comprises determining a second channel to decode based upon the channel below the first channel in a favorite channel list.

24. A method for improving the channel selection performance of compressed digital video systems in accordance with claim 18, wherein the step of determining a second channel to decode comprises determining a second channel to decode based upon the last channel viewed.

25. A method for improving the channel selection performance of compressed multimedia systems, the method comprising:
receiving a broadband stream including a plurality of individual channels;
receiving a selection of a first one of the plurality of individual channels;
decoding the first one of the plurality of individual channels to produce a decoded individual channel;
sending the decoded individual channel to a display;
determining a second one of the plurality of individual channels to decode; and
decoding the second one of the plurality of individual channels before a selection of the second one of the plurality of individual channels is received.

26. A method for improving the channel selection performance of compressed multimedia systems in accordance with claim 25, wherein the step of determining the second one of the plurality of individual channels comprises choosing a channel adjacent to the first one of the plurality of individual channels.

27. A method for improving the channel selection performance of compressed multimedia systems in accordance with claim 26, wherein the step of choosing a channel adjacent to the first one of the plurality of individual channels comprises choosing the channel above the first one of the plurality of individual channels.

28. A method for improving the channel selection performance of compressed multimedia systems in accordance with claim 26, wherein the step of choosing a channel adjacent to the first one of the plurality of individual channels comprises choosing the channel below the first one of the plurality of individual channels.

29. A method for improving the channel selection performance of compressed multimedia systems in accordance with claim 25, wherein the step of determining the second one of the plurality of individual channels comprises choosing a channel from a favorites list.

30. A method for improving the channel selection performance of compressed multimedia systems in accordance with claim 25, wherein the step of determining the second one of the plurality of individual channels comprises choosing the previous channel selected.

31. A method of decoding compressed multimedia streams, the method comprising:
receiving a broadband transport stream;
distributing the broadband transport stream to a plurality of stream selectors;
decompressing the output of the plurality of stream selectors to a plurality of base signals;
selecting a desired one from among the plurality of base signals;
displaying the desired one signal;
providing a user interface for receiving a selection of a channel from a user;
anticipating the next channel the user will select; and
programming the plurality of stream selectors in response to the next channel.

32. A method of decoding compressed multimedia streams in accordance with claim 31, wherein the step of anticipating the next channel the user will select comprises selecting the channel above the desired one signal.

33. A method of decoding compressed multimedia streams in accordance with claim 31, wherein the step of anticipating the next channel the user will select comprises selecting the channel below the desired one signal.

34. A method of decoding compressed multimedia streams in accordance with claim 31, wherein the step of anticipating the next channel the user will select comprises selecting the channel above the desired one signal in a favorite channel list.

35. A method of decoding compressed multimedia streams in accordance with claim 31, wherein the step of anticipating the next channel the user will select comprises selecting the channel below the desired one signal in a favorite channel list.

36. A method of decoding compressed multimedia streams in accordance with claim 31, wherein the step of anticipating the next channel the user will select comprises selecting the last channel viewed.
